(19) United States
(12) Patent Application Publication
(10) Pub. No.: US 2011/0119577 A1
(43) Pub. Date: May 19, 2011

(54) METHOD AND APPARATUS FOR ASSOCIATING A PLURALITY OF PROCESSING FUNCTIONS WITH A TEXT

(76) Inventors: Lionel Audant, Longueuil (CA); Pascal Audant, Montreal (CA)

(21) Appl. No.: 12/921,346

(22) PCT Filed: Feb. 26, 2009
(86) PCT No.: PCT/CA2009/000244

§ 371 Date: Nov. 23, 2010

Related U.S. Application Data
(60) Provisional application No. 61/034,701, filed on Mar. 7, 2008.

(51) Int. Cl. G06F 17/27

(52) U.S. Cl. 715/256

(57) ABSTRACT

A method and apparatus are provided for associating a plurality of processing functions with a text, the method comprising parsing the text into a plurality of propositions detecting at least one proposition having one of a narrative style and a descriptive style; for each of the detected at least one proposition; identifying a subject and a corresponding action at a given proposition; associating a first set of values to a first plurality of properties related to the subject of the given proposition; associating a second set of values to a second plurality of properties related to a kernel comprising the subject and the corresponding action of the given proposition; associating a third set of values to a third plurality of properties related to the given proposition and mapping at least one of the plurality of processing functions to the given proposition using at least one of the first set of values, the second set of values and the third set of values to thereby associate a plurality of functions to the text.

### CROSS REFERENCE TO RELATED APPLICATIONS

This patent application claims priority of U.S. Provisional Patent Application No. 61/034,701, entitled “Method and apparatus for associating a plurality of processing functions with a text” that was filed on Mar. 7, 2008, the specification of which is hereby incorporated by reference.

### FIELD OF THE INVENTION

The invention relates to text analysis. More precisely, this invention pertains to a method and apparatus for associating a plurality of functions with a text.

### BACKGROUND OF THE INVENTION

It is of great interest to be able to readily analyze texts.

Unfortunately, most of the applications available today which allows to link a text with animations are limited to a defined and limited domain which is a great drawback.

Moreover many methods are based on statistical approaches or on machine-learning approaches which may suffer from many limitations.

In fact, a statistical approach will use statistics to analyze a text which means that a given probability will be attached to the method which is a great limitation.

A machine learning approach will be limited to a given user style which is also a great limitation.

There is a need for a method and apparatus that will overcome at least one of the above-identified drawbacks.

Features of the invention will be apparent from review of the disclosure, drawings and description of the invention below.

### BRIEF SUMMARY

According to one embodiment, there is provided a method for associating a plurality of processing functions with a text, the method comprising parsing the text into a plurality of propositions, detecting at least one proposition having one of a narrative style and a descriptive style, for each of the detected at least one proposition; identifying a subject and a corresponding action at a given proposition; associating a first set of values to a first plurality of properties related to the subject of the given proposition; associating a second set of values to a second plurality of properties related to a kernel comprising the subject and the corresponding action of the given proposition; associating a third set of values to a third plurality of properties related to the given proposition and mapping at least of the plurality of processing functions to the given proposition using at least one of the first set of values, the second set of values and the third set of values to thereby associate a plurality of functions to the text.

In one embodiment of the method the parsing of said text is performed using semantic tags.

In yet another embodiment, the method further comprises providing the text.

In another embodiment, the providing of the text comprises one of retrieving the text from a local repository and downloading the text from a server.

In an embodiment the first set of properties comprises “quantity”, “quality”, “posture”, “relation” and “location” properties.

In yet another embodiment, the second set of properties comprises “quality”, “quantity”, “location”, “time” and “relation” properties.

In yet another embodiment, the third set of properties comprises “location” and “time” properties.

In an embodiment, the plurality of processing functions comprises graphics objects.

In yet another embodiment, the method further comprises displaying issues to a user and requesting the user to provide a feedback.

In yet another embodiment, the displaying of the issues comprises displaying a visual indication of the issues to the user.

According to another embodiment, there is provided a method for associating a plurality of graphics objects with a text, the method comprising parsing the text into a plurality of propositions, detecting at least one proposition having one of a narrative style and a descriptive style, for each of the detected at least one proposition, identifying a subject and a corresponding action at a given proposition, associating a first set of values to a first plurality of properties related to the subject of the given proposition, associating a second set of values to a second plurality of properties related to a kernel comprising the subject and the corresponding action of the given proposition, associating a third set of values to a third plurality of properties related to the given proposition, mapping at least one of the plurality of graphics objects to the given proposition using at least one of the first set of values, the second set of values and the third set of values; and displaying the mapped at least one of the plurality of graphics objects.

In accordance with an embodiment, the displaying of the mapped at least one of the plurality of graphics objects comprises receiving a feedback from an operator, amending the mapping of the at least one of the plurality of graphics objects and displaying the amended mapping.

### BRIEF DESCRIPTION OF THE DRAWINGS

In order that the invention may be readily understood, embodiments of the invention are illustrated by way of example in the accompanying drawings.

FIG. 1 is a flowchart which shows one embodiment of a method for associating a plurality of processing functions with a text.

FIG. 2 is a flowchart which shows one embodiment of a method for detecting a proposition having one of a narrative style and a descriptive style.

FIG. 3 is a flowchart which shown one embodiment of a method for identifying a subject and a corresponding action in a given proposition.

FIG. 4 is a block diagram which shows an embodiment of a processing device in which the method for associating a plurality of processing functions with a text may be implemented.

FIG. 5 is a diagram which shows one embodiment of a representation of a substance with two corresponding properties.

FIG. 6 is a diagram which shows one embodiment of an implementation of the method for associating a plurality of processing functions with a text.

FIG. 7 is a diagram which shows one embodiment of a data structure for one implementation of the method for associating a plurality of processing functions with a text.

Further details of the invention and its advantages will be apparent from the detailed description included below.

### DETAILED DESCRIPTION

In the following description of the embodiments, references to the accompanying drawings are by way of illustration of an example by which the invention may be practiced. It will be understood that other embodiments may be made without departing from the scope of the invention disclosed.

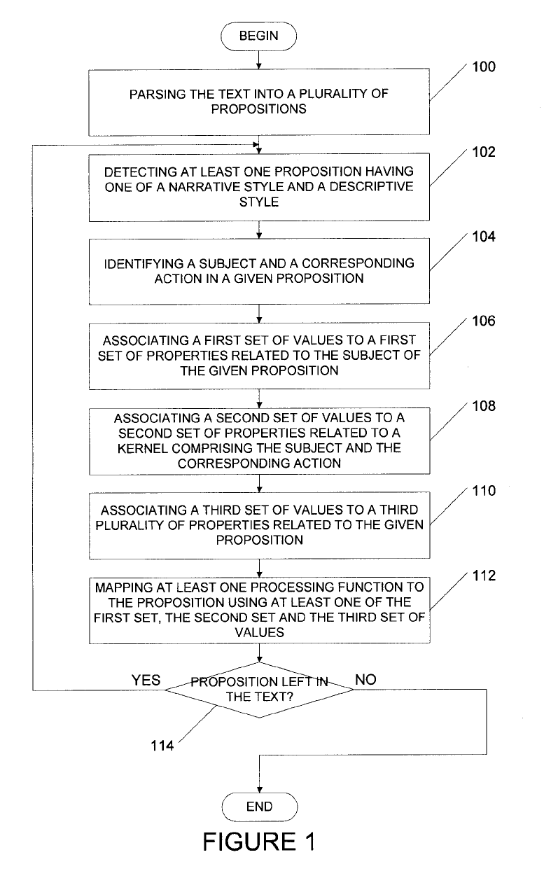

Now referring to FIG. 1, there is shown one embodiment of a method for associating a plurality of processing functions with a text.

According to processing step 100, a text is parsed into a plurality of propositions.

It will be appreciated by the skilled addressee that the text may originate from various locations and may be in various formats. For instance the text may be retrieved from a local repository. Alternatively, the text may be downloaded from a server. In still another embodiment, the text may be provided by an application.

It will be appreciated that the text may be provided in various formats such as html, ASCII or the like.

In one embodiment, the text is parsed according to the theory of semantic tags.

Moreover, it will be appreciated that the parsing of the text may be performed using semantic tags such as punctuation signs or relation markers.

Moreover and in one embodiment, the parsing of the text may be performed in consideration with various rules described herein below.

For instance, according to a first rule, a hierarchy is created between all the semantic tags. For instance, the punctuation mark (.) comes before the relation markers (e.g. but, however, when, because), the semi colon (;) and then the comma.

According to a second rule, at least one of the semantic tags may have another function aside separating the text into propositions. For instance, “meanwhile” will also indicate a time relation as well as being a semantic tag, “because” will also indicate a causality effect.

According to a third rule, some words may have a second function, which may be to act as a semantic tag or something else. For instance “and” might be a semantic tag but it might also play the role of a coordinating conjunctions.

For instance: “he sings and he dances”=semantic tag. His leg and his head hurt violently the door=coordinating conjunctions (between “leg” and “head”).

According to a fourth rule, two semantic tags may not be contiguous in between two propositions. In the case where two semantic tags are contiguous in a same given text, the semantic tag having a lower rank in the hierarchy may have another function. For instance “he walks the street. At the end of the street a dog barks.”

According to a fifth rule, some exceptions to the rules listed above may be taken into consideration.

For instance, a first exception to the rules disclosed above may be the “interpolated clause”, or the “incidental clause”. It will be appreciated that an “interpolated clause” is an element of information or an entire proposition that has been added in the middle of another proposition. For instance David will sing, he says, Shubert's Ave Maria. There are two propositions here, however one is inserted in the midst of the other: “David will sing Shubert's Ave Maria” and then: “David says he will sing Shubert's Ave Maria”. As shown, the first proposition results of removing the interpolated clause. Without removing the interpolated clause we would have an error in the second part ‘Shubert's Ave Maria=doesn't have an action.

It will be appreciated that it is possible to locate an “interpolated clause” since the “interpolated clause” is located between two commas and may cause incoherence during the parsing. More precisely, either the “interpolated clause” does not respect the fourth rule or it does not have a valid substance.

In one embodiment, the “interpolated clause” may be first removed from the proposition from which it has been located and may then be repositioned in that proposition.

Another exception to the above-listed rules is an enumeration or listing of elements. Those elements may be from a same type and may be separated from each other using a semantic tag such as a comma. In order to identify an enumeration of elements, a repetition of a same semantic tag may be detected.

Moreover, it will be appreciated that the semantic tags of an enumeration of elements delimitate a same type of structure. In the case where an enumeration of elements is identified, the elements must be linked together. If an operation is performed by an element of the enumeration, it will be applied in the same proportion to all the elements of the enumeration.

Moreover, it will be appreciated that the function of the various semantic tags may be dependent on the language used. It will be appreciated that in fact some semantic tags may be used to identify the subject of the proposition.

For instance, the variable substance “qui” in French, always replaces the subject, while the variable substance “que” never plays a role of subject in a proposition.

Still referring to FIG. 1 and according to processing step 102, at least one proposition having one of a narrative style and a descriptive style is detected.

As known by the skilled addressee, the descriptive style enables to describe and to position substances with respect to others or to describe in a very elaborate way various substances. It will be appreciated that the word substance as well as the various properties (e.g. quality, action, etc) are taken from the Organon from Aristotle. It will be appreciated that a substance may be defined as any physical object.

According to one embodiment the descriptive style may be identified using a list of actions, also referred to as a list of descriptive actions, which may be used in the description.

For instance in French: “voir”, “apercevoir”, verbe d'état, etc. When one of those descriptive actions is identified a flag of mutation may be raised in one embodiment. The flag of mutation will help determining that a proposition is in a descriptive style in the case where it is not possible to find a subject for the proposition or in the case where the subject cannot execute the descriptive action.

On the other end, the narrative style enables the animation of a subject in a given proposition.

Accordingly, if the proposition does not comprise a descriptive action, the proposition is supposed to be in a narrative style.

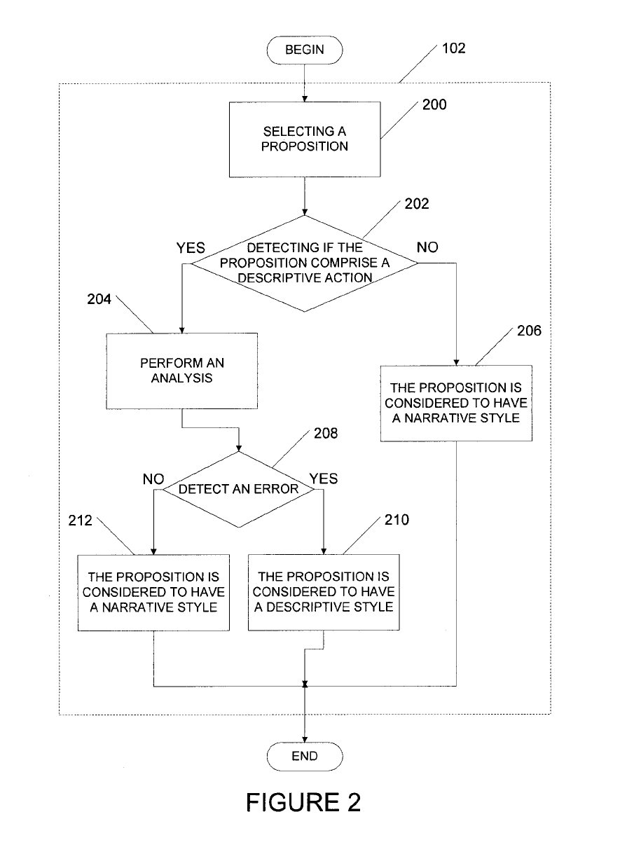

Now referring to FIG. 2, there is shown one embodiment for detecting a proposition having one of a narrative style and a descriptive style.

According to processing step 200, a proposition is selected. The proposition is selected from the plurality of propositions.

According to processing step 202, a test is performed to find out if the selected proposition comprises a descriptive action. In one embodiment, the test is performed by using a list of descriptive actions as mentioned above and comparing the selected proposition with the list of descriptive actions.

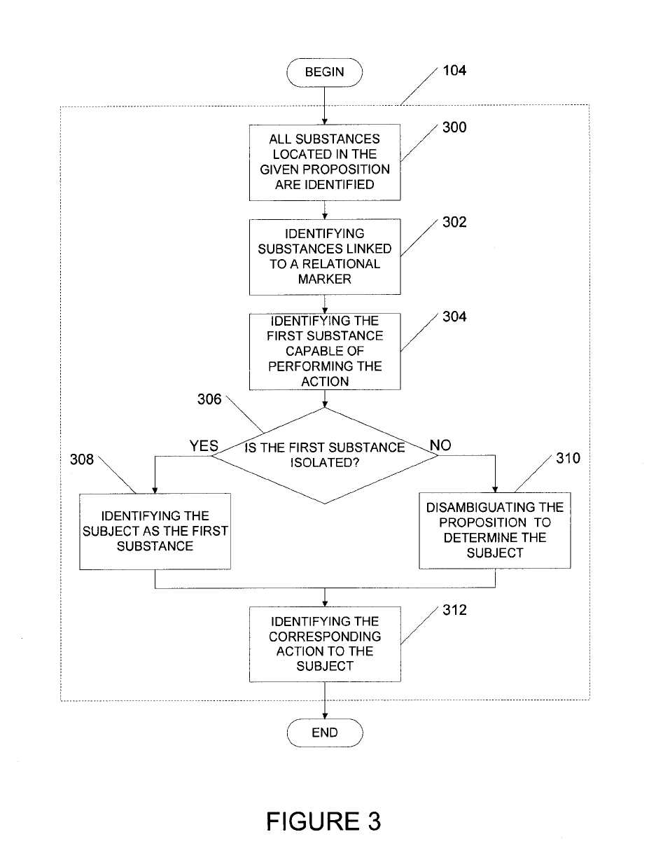

If the selected proposition comprises a descriptive action and according to processing step 204, an analysis is performed. The analysis is performed in order to validate for instance that the given proposition which has a descriptive action has a corresponding subject. The skilled addressee will appreciate that in one embodiment the analysis performed is similar to the analysis disclosed in FIG. 3.

According to processing step 208, a test is performed to find out if an error has been detected in the analysis.

In the case where an error has been detected and according to processing step 210, the selected proposition is considered to have a descriptive style.

In the case where no error has been detected and according to processing step 212, the selected proposition is considered to have a narrative style.

In the case where the selected proposition does not comprise a descriptive action and according to processing step 206, the selected proposition is considered to have a narrative style.

The skilled addressee will appreciate that the list comprising a plurality of descriptive actions is dependant on a given language.

Now referring back to FIG. 1 and for each of the detected at least one proposition and according to processing step 104, a subject and a corresponding action are identified in the given proposition.

In the case where the given proposition has a narrative style, a graphics object that will perform the action in the given proposition has to be identified. Such graphics object is referred to as the subject of the given proposition.

Using the subject of the given proposition, it is possible to determine the action of the given proposition. It is then possible to generate a “couple” which will be useful in order to have an idea of the “general idea” of the given proposition.

More precisely and in one embodiment, the subject is defined for the given proposition as the visual element around which gravitate the other elements of the given proposition.

Now referring to FIG. 3, there is shown an embodiment of a method for identifying a subject and a corresponding action in a given proposition.

According to processing step 300, all substances located in the proposition are identified.

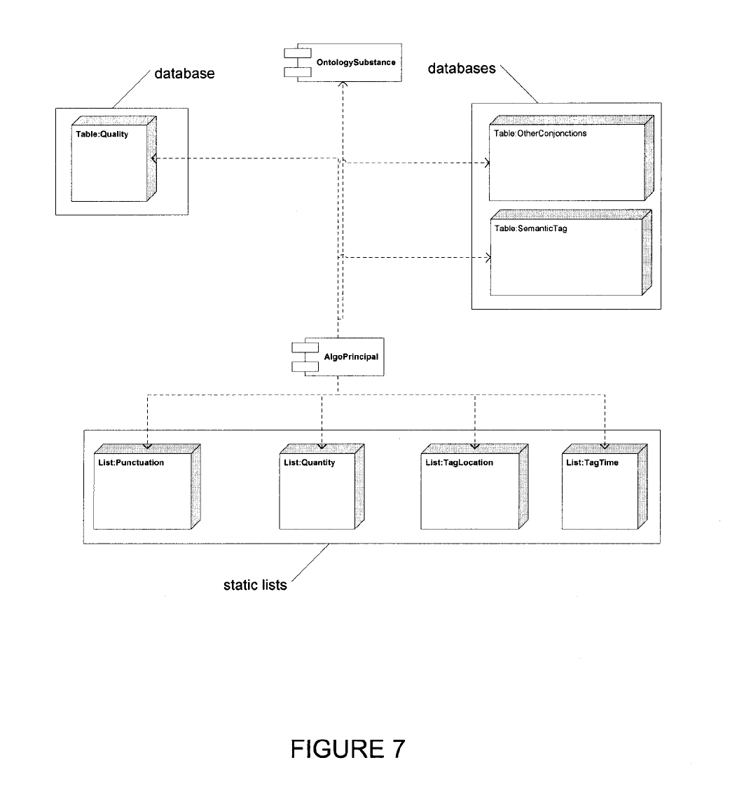

In one embodiment, all known substances may be stored in a Substance Ontology dictionary as shown in FIG. 7.

According to processing step 302, all the substances linked to a relational marker are identified.

In one embodiment, the substances linked to a relational marker are identified using markers located in a database List of markers while substances are located in the Substance Ontology.

According to processing step 304, the first substance capable of performing the action is identified.

According to processing step 306, a test is performed in order to find out if the first substance without a marker capable of performing the action is isolated.

In the case where the first substance without a marker capable of performing the action is isolated and according to processing step 308, the subject is identified as being the first substance without a marker of the given proposition capable of performing the action.

It will be appreciated by the skilled addressee that in order to be acceptable as the subject of the proposition, the first substance without a marker must be isolated. In fact, in the case where a first given substance is contiguous with a second given substance which is also capable of performing the action, the rule of the first substance does not apply.

More precisely, in the case of a first substance contiguous with a second substance and according to processing step 310, the proposition is disambiguated using a method for disambiguating the proposition. It will be appreciated that the method for disambiguating the proposition may be language-specific.

It will be appreciated by the skilled addressee that relationships expressions such as “son of”, “parent of”, “friend of”, as well as all the pronouns are referred to as elements, meaning that they may replace a subject that was in memory. It will also be appreciated that in certain languages, the absence of subject may mean in fact that there is a substance that should be used instead of the subject.

It will be appreciated by the skilled addressee that in a narrative style, an action relates to the function of animation of the subject. In one embodiment, the list of possible actions for a given subject as well as all its hierarchical descendants is also stored at the level of the substance.

Still referring to FIG. 3 and according to processing step 312, the action corresponding to the subject is identified.

More precisely and in one embodiment, all the other terms of the proposition that are not the subject of the proposition are checked against a list of possible actions of the subject as well as all the possible actions of the logical superiors of the subject when the subject of the given proposition is identified.

It will be appreciated that a variable action may occur when the subject and the action have to be determined by an external factor such as the environment. In fact, there exist some words which cannot be resolved in order to know exactly what will be the action to perform. For instance, the bird is moving is equal to knowing that he moves. If the bird is in the air then the movement relates to flying, while if it is on the ground the movement relates to walking.

It will be appreciated that in the case where no action can be found in the list of the subject and its logical superiors, there is then a conflict situation that will have to be solved. In one embodiment, a notification flag may be raised. It has been contemplated that various reasons may explain such conflict situation.

A first reason for a conflict situation may be a bad context, i.e. the subject has another meaning.

A second reason for a conflict situation may be that there exists no action in the given proposition. This may mean that the subject will be reused in the proposition following the given proposition. In one embodiment and in such case, a notification flag may be raised and then lowered in the future.

A third reason for a conflict situation may be that there is a bad identification of the subject. In such case and in one embodiment, a notification flag may be raised.

Now referring back to FIG. 1 and according to processing step 106, a first set of values is associated to a first plurality of properties related to the identified subject of the given proposition.

It has been contemplated that there exists a “wave-particle” duality which enables a transition between the text and animation in the case where the plurality of processing functions are related to animations functions. Under this duality, it has been contemplated that the “particle aspect” of a given object may be represented by its concept and its textual form per se while the “wave aspect” of the given object may be represented by its graphics image and its movement in time in the case where the plurality of functions relate to graphics functions.

Graphics objects may therefore have two distinct forms during the analysis procedure described herein. In fact, the “particle aspect” may first be identified while the “wave aspect” of the graphics objects may then be identified. The graphics objects are first identified before performing the analysis of the two forms.

The graphics object may comprise the subject, the subject and the corresponding action and the proposition.

In its “wave aspect”, the subject projects in an infinite way in time.

The subject and the corresponding action result from the corporality of the combination of a wave of the subject with its action. In its wave aspect, the subject and the corresponding action projects itself equally in an infinite way in time.

Finally, the proposition results from the corporality of a wave of the subject and the corresponding action. In its wave aspect, the proposition projects itself in finite way in time.

It will be appreciated that the corpuscular aspect enables the analysis of an object. Under this form it is possible to add or remove satellites to an object as well as to modify its property. The particle aspect of an object exists outside time and thus outside the animation. It will be further appreciated that the particle aspect may also be used in any operation of word processing such as operation research, abstract of a text, translation, or the like.

It will be also appreciated by the skilled addressee that the particle aspect may be viewed as relating to a textual/conceptual form of an idea.

Contrary to the “particle aspect”, the “wave aspect” enables the display of a graphics object. Under this aspect, it is possible to display an object in an animation form for instance. The “wave aspect” of an object always exists according to a temporal scale that can be infinite. It is possible to say that the “wave aspect” relates to the graphics representation for the projection of an idea. The “wave aspect” could also be related to any execution code other than animation for instance Artificial Intelligence or control functions etc.

As mentioned previously, the subject identifies the substance that is performing an action in the given proposition. However, the method disclosed below may have to be reapplied to all the other substances whether they are visible or not.

It has been contemplated that in its “particle aspect”, the subject comprises the properties “quantity”, “quality”, “posture”, “relation” and “location”.

By definition, the “quantity” property applies to all categories except itself.

The various “quantity” property values may be located in a list that varies depending on the language used. It may be possible to group the “quantity” property values in various sub-categories. A discrete “quantity” property value enables to know the number of occurrences of an object to which it is applied. A continuous “quantity” property value affects the dimension of an object to which it applies. A defined “quantity” property value relates to an identifiable number. An indefinite “quantity” property value applies to an increase or reduction to a discrete or continuous “quantity” property value. It will be appreciated that the “quantity” property value will always be around an object that it affects. The only thing that may be found between an object and the “quantity” property value that is affecting it is a “quantity” property value or a “quality” property value. It may be therefore only necessary to search around (i.e. before and after) a pertaining object until a “quantity” property value or a “quality” property value is found.

The “quality” property enables the modifying of a texture, a form or a behavior of an object. It will be appreciated that there exist many sub-categories to the “quality” property such as for instance the color, the attributes of forms, the texture, the speed and the intensity, etc.

Values for the “quality” property may be located in a database in one embodiment. It has been contemplated that similar to the “quantity” property, the “quality” property may be located around the object that it affects. The only thing that may be found between an object and the “quality” property that is affecting it is a “quantity” property value or a “quality” property value. It may therefore be necessary, in one embodiment, to search around (i.e. before and after) a pertaining object until it is possible to find another property value than a “quantity” property value or a “quality” property value.

It will be appreciated that the “posture” property is a definition of a particular position of a substance. It is only possible to apply one “posture” property value to one substance in one embodiment. The application of a second “posture” property value may therefore cancel the previous one. The “posture” property will generally affect the animation of a given substance. Moreover, contrary to the “quality” property values and the “quantity” property values, the “posture” property values are in defined numbers.

Like the action, the “posture” property values may be listed in an ontology of the substances. The “posture” property values may be represented as a result of an action. While the “posture” property value may be the result of an action, it is a state. For example: “the man sits” means that at the end of the action the man will have a sitting posture. On the other hand, “the man sitting in front of a screen”, the start position of the man is sitting without requiring any animation.

The “relation” property applies to all objects as for “quantity” property. However, the type or the category of “relation” property value changes depending on the type of objects to which the “relation” property is applied to. For instance, it is possible to find as a “relation” property value applied to a substance a family relation (“son of”, “parent of”, “cousin of”, etc.), a relation of possession (“Mary's dog”, “the family house”) and a relation of comparison (“larger than”, “quicker than”, etc.).

It is pertinent to note that the “relation” property value of a subject of a proposition is always a substance that will not be displayed during the animation.

Relations always link two kernels. In the case of a subject, the “relation” property value will link the subject with another substance. The “relation” property values may be identified at the last step of the method. In fact, it may be required to identify two substances in relation and then to identify the type of “relation” property value between them. Since the type of “relation” property value depends on the relational marker or from the position of an element towards the other one, it will be appreciated by the skilled addressee that the method for identifying the “relation” property values of the subject may vary depending on the language.

As per the “relation” property, the “location” property applies to all type of objects. Contrary to the “relation” property, the “location” property always applies in the same manner whatever the type of object is concerned. As per the “posture” property, it is not possible to apply a single “location” property value per object. The application of a second “location” property value to an object replaces the first “location” property value and should generate a confirmation flag except in the case where the change of “location” property value is the result of an action of displacement.

It will be appreciated that all the “location” property values are represented by what is called a non subject substance or image substance (substance=a physical object). It is the substance that will have a graphics equivalent during animation but that does not affect any actions specific in the case of this proposition.

With regards to its identification, it is necessary at the beginning to differentiate the “location” property from a “relation” property substance. In fact it will be appreciated that a “relation” property value will always be accompanied by a relational marker. However, all the relational markers showing a location are limited. It is therefore possible to introduce them in a list.

It is believed that the method used to identify the “location” property value associated with a substance may be dependent on the language analyzed.

Still referring to FIG. 1 and according to processing step 108, a second set of values is associated to a second plurality of properties related to a kernel comprising the subject and the corresponding action of the given proposition.

After the subject has been analyzed, the subject is merged with its corresponding action to create what is referred to as a kernel subject-action. As the subject, the kernel subject-action has a particle form and a wave form.

Under its particle form, the plurality of properties of the kernel subject-action comprises a “quality” property, a “quantity” property, a “location” property, a “time” property and a “relation” property.

The nature and the role of the “quantity” and “quality” properties do not change. It is also possible to identify them in the same manner as per the subject. They are usually the action word and are limited by relational markers. A recursive research from each end of an action word may identify the “quantity” and “quality” property values that apply to the corresponding “quantity” and “quality” properties of the kernel subject-action.

It will be appreciated that in the case of the kernel subject-action, the “location” property plays a fundamental role. In fact, certain actions cannot be done without a “location” property value and a direction. Moreover, the kernel subject-action may have many “location” property values at the opposite of a subject, such as direction of the action, the location of the action, the target of the action. As per the subject, the “location” property values are always represented by the subject-image and will therefore have a wave equivalent.

The “location” property value of the kernel subject-action may be identified in two ways, i.e. using its relational marker or using a mapping of the action. As previously mentioned, certain actions require specific parameters in order to be valid, such as time location and complement. For instance, the verb “aller” (i.e. to go) in French requires to be immediately followed by a “location” property value (exception Quality/Quantity) in order to be valid. For instance “je vais à la plage” (i.e. I go to the beach) will be validated by the method. At the opposite, “je vais manger des pommes” (i.e. I am going to eat apples) is invalid, “je vais manger en ville” (i.e. I am going to eat in the city), will also be invalid when using the method since the action is not immediately followed by a “location” property value. In the case where the method invalidates an action it is necessary to identify a new action. If the new action cannot be identified then a notification flag may be raised.

The “time” property has an impact on the duration of a resulting animation in the case where an animation is performed. Either it is possible to determine directly a “time” property value (e.g. “le chien mange en 5 secondes”) (i.e. the dog eats in 5 seconds) or the “time” property value is established with another kernel. It is then possible to have some simultaneous relations such as (“la femme chante et danse”) (i.e. the women is singing and dancing) preceding relations (“il mange avant de sortir”) (i.e. he is eating before going out) or follow-up. At this time, the duration of the action must be computed during the resolution of the space-time chain.

It will be appreciated that it is possible to have two “time” property values for a single kernel subject-action one of which is a duration value and the other is a “relation” with another kernel subject-action.

The “time” property value is identified by a relational marker in one embodiment. In the case of actions that require specific parameters, the “time” property is there since it is inherent to a movement. However, it is possible that an action with restrictions on its “time” property requires a positioning that is specific with respect to the “time” property.

While the “relation” property has the same name, the “relation” property of a kernel subject-action is different from the “relation” property of a subject. The “relation” property values of the subject-action are, in fact, complements of the action as defined in most grammars. It may be therefore required to eliminate all the complements that are making reference to a location.

At the contrary of the “relation” property of a subject, the “relation” property of the kernel substance-action will always be a substance which means that it will always have a wave form in the given proposition.

Now referring back to FIG. 1 and according to processing step 110, a third set of values is associated to a third plurality of properties related to the given proposition.

It will be appreciated that after the kernel subject-action of the given proposition is analyzed, the given proposition is analyzed.

The given proposition is defined by the subject matter between the two semantical tags. The properties of the kernel subject-action will be located outside these two semantical tags. There exist therefore two types of values for a proposition, the subordinated clause and the interpolated clause.

It will be appreciated that the subordinated clause is generally linked with a link of location or simply the resolution of a variable substance. In such case, there is a relation between two complete propositions.

Generally, the interpolated clause adds a complement of information to the proposition. Either a “location” value, a “time” value, a qualification of substance or a resolution of a variable substance. Accordingly, very frequently there will be a proposition with a “location” property value and a “time” property value.

It will be therefore appreciated that the kernel proposition usually comes with the properties “location” and “time”.

As defined and identified in the kernel subject-action, the “location” property involves the proposition as well as a subject indicating a location. It does not relate only to a relation involving a given proposition with another given one.

The “time” property is defined and identified as in the kernel subject-action. However, contrary to a temporal relation involving the kernel subject-action, there is no duration in the “time” of a proposition. It is simply a relation of time between two propositions that can take the values “simultaneous”, “before” or “after”.

Still referring to FIG. 1 and according to processing step 112, at least one of the plurality of processing functions is mapped to the given proposition using at least one of the first set of values, the second set of values and the third set of values.

It will be appreciated that the processing functions may be any type of processing functions such as graphics images (also referred to as graphics objects), sequence of data, auto-generated executable code, control signals or the like.

In the case where the processing functions comprise graphics objects, the mapping is used to associate at least one of the plurality of graphics objects to the given proposition using at least one of the first set of values, the second set of values and the third set of values to thereby associate a plurality of functions to the text. It will be appreciated that in such embodiment the at least one graphics objects mapped to the given proposition may be displayed to a user.

The skilled addressee will appreciate that at least one part of the proposition may then be “expressed” using the graphics objects which may be of great advantage. In fact, mapping the given proposition into graphics objects and displaying the corresponding result may be used for helping the teaching/learning of a foreign language for instance since a teacher/student may readily see the results of a given proposition with corresponding graphics objects.

Alternatively, the method disclosed above may be further advantageously used to translate a given proposition into an animation which is of great advantage. It may facilitate the adaptation of texts into animation.

In fact, a large number of animations may be created using a limited amount of graphics objects and texts.

Moreover, it will be appreciated that a writer may convert his/her texts into animations which may be of great advantage for him/her to reach a broader audience.

While some issues may occur during the translation, the skilled addressee will appreciate that a user interface may be provided to the user with means for amending the mapping of the at least one processing functions to the given proposition. Such means may comprise editing means for adding/removing graphics objects on the user interface for instance. The skilled addressee will appreciate that such tools may be used to facilitate the mapping with the further input of an operator.

Still referring to FIG. 1 and according to processing step 114, a test is performed in order to find out if there is at least one proposition left.

It will be appreciated that in one embodiment particular cases are processed.

In fact, it has been contemplated that there exists some cases and some elements that the method disclosed above cannot solve after a first processing.

In such case, the procedure for processing the particular cases is to put a flag indicating to the system that it will come back to handle a given problematic proposition upon completion of other propositions of the text, chapter, paragraph or sentence for instance.

Amongst the cases that are not readily solvable there exists for instance what is referred to as “variable substance”. More precisely, a “variable substance” is defined as any term that is put for a substance. The notion of a “variable substance” may vary depending on the language. Amongst the known “variable substances” there exists the pronoun. The pronoun is the most common type of “variable substance”. Depending on the pronoun, the “variable substance” may play a role in the subject, the substance and then have an impact more or less on the given text.

In the case where a substance is the result of a comparison with another substance, a “variable substance” is created. For instance, “the son of Xavier” is a “variable substance”; “the tallest of the family” is also a “variable substance”.

It will be appreciated that in certain languages, it is possible to remove the subject because of the declination of the verb, such as for instance in Arabic.

It will be appreciated that it may be possible to solve the problem of the “variable substance” by memorizing all the substances found in the document. By deducting and prioritizing some of the substances, it is possible to find out the substance replaced by the “variable substance”.

In one embodiment, a memorizing unit may be provided for recording all the substances of a text. However, in the case where the text is large, there may be some risks of going beyond the resources required by the system. It will be appreciated by the skilled addressee that there may be a need for a recycling method that will remove from the memorizing unit any substances that have not been referred to recently.

Certain actions presuppose other actions. For instance, the action of moving presupposes the action of walking, running, flying or swimming. The action of continuing makes reference to a previous action.

Considering that an occurrence of a “variable action” may be rare in a text, it may be preferable to redo the analysis of preceding sentences until a kernel subject-action corresponding to a subject of the “variable action” is found. In the case where the “variable action” replaces an action depending on the context of the environment or the location, it is required to access a list of actions for the subject and to choose the action that relates the best to the properties values of the kernel “substance-variable”-Action.

Contiguous substances are language-related issues. For instance, it is impossible to find two contiguous substances in French. Their resolution therefore requires specific methods to be implemented that are language-dependent.

It will be further appreciated that homonyms may create, by definition, some conflicts in context. In order to solve the conflicts efficiently, it is required to access the context to which they intervene. It may also be necessary to know their existence in a provided ontology. The homonyms are by definition dependent on the ontology of each language.

It will be appreciated that in one embodiment, a feedback may be provided to a user.

More precisely, once the analysis is completed and in one embodiment, the apparatus may write the text using its own comprehension of the elements. Moreover, identified problems may be displayed using colors in one embodiment and a feedback may be requested from the user. The user may have the choice of rewriting the sentence or using a graphics mode or the wave mode in order to solve the issue of disambiguation.

The feedback graphics user interface provided to the user may comprise the following elements and operations.

A proposition filter may be used to enable the user to only show pertinent propositions that have problems or more precisely the propositions that have a context conflict. Each of the flags that may be found in the method may be used as a filter.

A list of the substances that have been identified during the analysis of the given text may be provided. It may be therefore possible for a user to recompose graphically the text by choosing some elements of this list.

A line of time tool may further be provided which is based on a toolbox based on the interface that can be found in the Flash of Adobe may further be used. Such tool may enable the user to locate the proposition in time with respect to the other propositions. There are three types of temporal relations between two propositions which are proposition A precedes proposition B, proposition A is simultaneous to proposition B; and proposition A is following proposition B.

A graphics construction tool which is in one embodiment a graphics editor may be provided. The graphics construction tool enables constructing a graphics object, which may be 3D or 2D, for the substance and that further enables the user to add texture. This graphics editor may also be used to create animation for the substances. Examples of graphics editors comprise 3DS Max, Softimage, Photoshop, and Illustrator.

After the graphics object is created the user may associate it directly to a substance or a substance-active.

In one embodiment, a confirmation may be used. The confirmation of a proposition indicates that the user has completed the modifications of a given proposition and that the computer may now re-analyze in order to check if the modifications made by the user enable the computer to converge towards an animation for the analyzed proposition.

Once the user has terminated to solve the conflicts and has confirmed and/or solved all of the problematic cases, the system undergoes the animation mode. The animation mode enables to display the animation resulting from the text according to the specification of the user. The skilled addressee will appreciate that this is performed in the case where processing functions comprises graphics functions. Alternatively, the processing functions may comprise a sequence of data or the like.

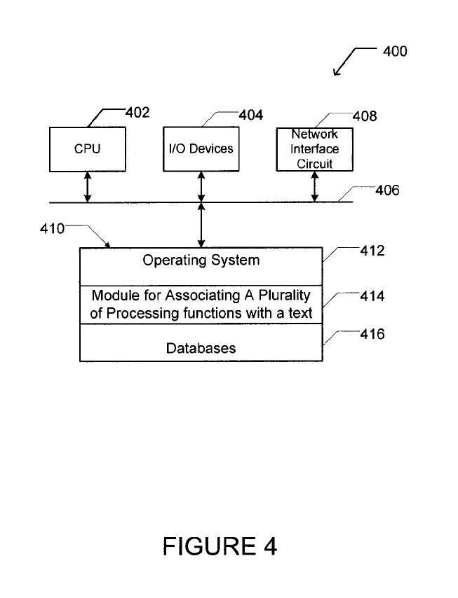

Now referring to FIG. 4, there is shown an embodiment of a processing device 400 in which the method for associating a plurality of processing functions with a text may be advantageously used.

The processing device 400 comprises a central processing unit 402, I/O devices 404, a network interface circuit 408, a data bus 406 and a memory 410.

The central processing unit 402, the I/O devices 404, the network interface circuit 408 and the memory 410 are operatively coupled using the data bus 406.

More precisely, the central processing unit 402 is adapted for processing data instructions. The network interface circuit 408 is adapted for operatively connecting the processing device 400 to another processing device, not shown, via a data network, not shown. The skilled addressee will appreciate various embodiments of the network interface circuit 408 may be provided. Moreover, the skilled addressee will appreciate that the network interface circuit 408 may operate according to various communication protocols such as TCP/IP for instance.

The I/O devices 404 are used for enabling a user to interact with the processing device 400. The skilled addressee will appreciate that various embodiments of the I/O devices 404 may be used. For instance, the I/O devices 404 may comprise a keyboard, a screen and a mouse.

The skilled addressee will appreciate that various embodiments of the data bus 406 may be provided.

It will be appreciated that various embodiment of the memory 410 may be used. Moreover, it will be appreciated that the memory 410 may be used to store in one embodiment an operating system 412, a module for associating a plurality of functions with a text 414 and databases 416 used for operating the module for associating a plurality of functions with a text 414.

The skilled addressee will appreciate that the operating system 412 is used for managing the interactions between the central processing unit 402, the I/O devices 404, the network interface circuit 408, the data bus 406 and the memory 410.

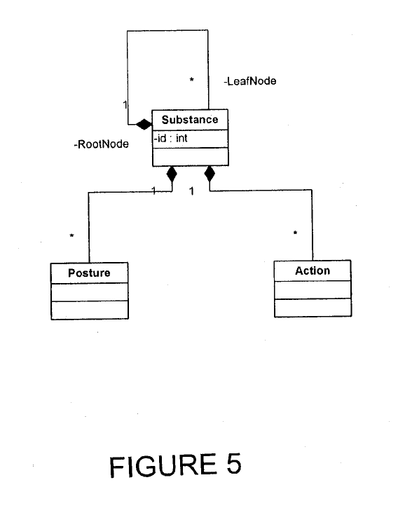

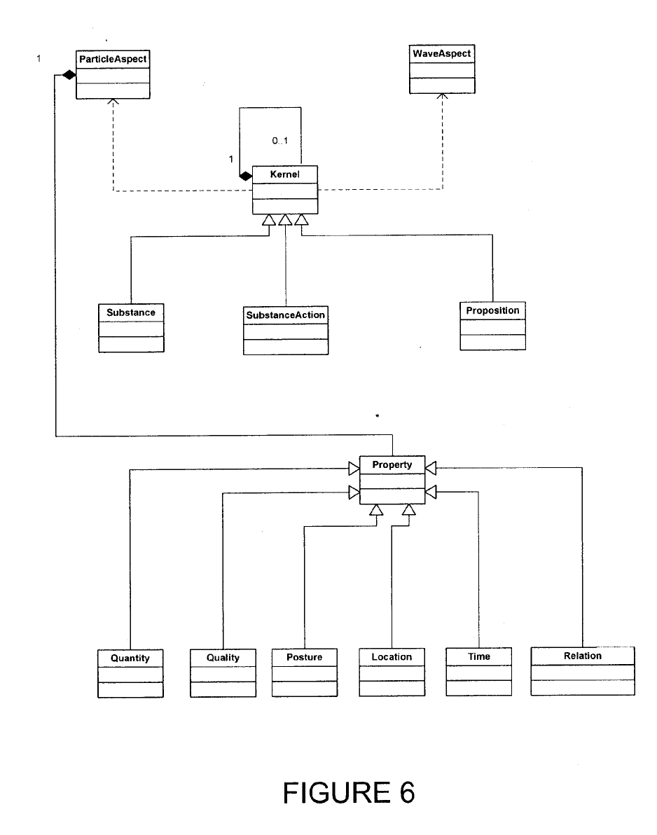

Now referring to FIGS. 5, 6 and 7, there are shown diagrams which show respectively one embodiment of a representation of a substance with two corresponding properties, one embodiment of an implementation of the method for associating a plurality of processing functions with a text and one embodiment of a data structure for one implementation of the method for associating a plurality of processing functions with a text.

It will be appreciated that the method disclosed herein is of great advantage since it enables an analysis of a given text and disclose a method for associating the text to a plurality of processing functions. In the case where the plurality of processing functions comprises graphics functions, the method disclosed herein enables to animate graphics in accordance with a text which is of great advantage.

1. A method for associating a plurality of processing functions with a text, the method comprising:
parsing the text into a plurality of propositions;
detecting at least one proposition having one of a narrative style and a descriptive style; and
for each of the detected at least one proposition:
identifying a subject and a corresponding action at a given proposition;
associating a first set of values to a first plurality of properties related to the subject of the given proposition;
associating a second set of values to a second plurality of properties related to a kernel comprising the subject and the corresponding action of the given proposition;
associating a third set of values to a third plurality of properties related to the given proposition; and
mapping at least one of the pluralities of processing functions to the given proposition using at least one of the first set of values, the second set of values and the third set of values to thereby associate a plurality of functions to the text.

2. The method as claimed in claim 1, wherein said parsing of said text is performed using semantic tags.

3. The method as claimed in claim 1, further comprising providing said text.

4. The method as claimed in claim 3, wherein said providing of said text comprises one of retrieving said text from a local repository and downloading said text from a server.

5. The method as claimed in claim 1, wherein the first set of properties comprises “quantity”, “quality”, “posture”, “relation” and “location” properties.

6. The method as claimed in claim 1, wherein the second set of properties comprises “quality”, “quantity”, “location”, “time” and “relation” properties.

7. The method as claimed in claim 1, wherein the third set of properties comprises “location” and “time” properties.

8. The method as claimed in claim 1, wherein said plurality of processing functions comprises graphics objects.

9. The method as claimed in claim 1, further comprising displaying issues to a user and requesting the user to provide a feedback.

10. The method as claimed in claim 9, wherein said displaying said issues comprises displaying a visual indication of the issues to the user.

11. A method for associating a plurality of graphics objects with a text, the method comprising:
parsing the text into a plurality of propositions;
detecting at least one proposition having one of a narrative style and a descriptive style; and
for each of the detected at least one proposition:
identifying a subject and a corresponding action at a given proposition;
associating a first set of values to a first plurality of properties related to the subject of the given proposition;
associating a second set of values to a second plurality of properties related to a kernel comprising the subject and the corresponding action of the given proposition;
associating a third set of values to a third plurality of properties related to the given proposition; and
mapping at least one of the plurality of graphics objects to the given proposition using at least one of the first set of values, the second set of values and the third set of values; and
displaying the mapped at least one of the plurality of graphics objects.

12. The method as claimed in claim 11, wherein the displaying of the mapped at least one of the plurality of graphics objects comprises receiving a feedback from an operator, amending the mapping of the at least one of the plurality of graphics objects and displaying the amended mapping.
